(19) United States
(12) Patent Application Publication
(10) Pub. No.: US 2026/0249774 A1
(43) Pub. Date: Aug. 27, 2026

(54) VEHICLES HAVING ACCESSORY MOUNTING ASSEMBLIES

(71) Applicant: Toyota Motor Engineering & Manufacturing North America, Inc., Plano, TX (US)

(72) Inventors: Aaron R. Steinhilb, Milan, MI (US); Timothy J. Woychowski, Howell, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/065,731

(22) Filed: Feb. 27, 2025

(51) Int. Cl. B60P 7/08; B60R 9/06

(52) U.S. Cl. CPC B60P 7/0807; B60R 9/06

(57) ABSTRACT

A vehicle includes a truck bed and an accessory mounting assembly. The truck bed includes side walls and a floor. The accessory mounting assembly includes an accessory and a front connector and a rear connector coupled to the floor. The accessory is configured to be releasably coupled to the floor. The accessory includes a housing, a front latch and a rear latch, the front latch and the rear latch are coupled to the housing and movable between a locked position and an unlocked position, in the locked position the front latch engages with the front connector and the rear latch engages with the rear connector to inhibit movement of the housing with respect to the floor, in the unlocked position the front latch is disengaged with the front connector and the rear latch is disengaged with the rear connector to permit the housing to move with respect to the floor.

### TECHNICAL FIELD

The present specification generally relates to accessory mounting assemblies and vehicles including the same.

### BACKGROUND

Vehicles are often equipped with open cargo areas, such as truck beds, used to transport goods. While truck beds can accommodate items of different sizes and shapes, users frequently require other compartments or accessories to organize and secure belongings. Many existing solutions, such as bed-mounted toolboxes or cargo management systems, provide some level of storage or organization. However, these solutions can be cumbersome to install or remove and may not securely latch to the truck bed. Additional challenges include addressing shifting loads during transport and ensuring any installed accessory remains stable. Conventional approaches, for instance those involving permanently mounted storage boxes or locking mechanisms, may not offer a quick-release option or an easy way to position the accessory. As a result, there is a need for an improved accessory mounting assembly configured to releasably attach to a truck bed and provide versatile, secure engagement that can be locked or unlocked with minimal effort.

### SUMMARY

In one embodiment, a vehicle includes a truck bed and an accessory mounting assembly. The truck bed includes a pair of side walls and a floor. The accessory mounting assembly having an accessory and a front connector and a rear connector coupled to the floor. The accessory is configured to be releasably coupled to the floor. The accessory includes a housing defining a storage space, a front latch and a rear latch, the front latch and the rear latch are coupled to the housing, the front latch and the rear latch are movable between a locked position and an unlocked position, in the locked position the front latch engages with the front connector and the rear latch engages with the rear connector to inhibit movement of the housing with respect to the floor, in the unlocked position the front latch is disengaged with the front connector and the rear latch is disengaged with the rear connector to permit the housing to move with respect to the floor.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top view of a vehicle having the accessory mounting assembly to releasably mount an accessory to a floor of a truck bed of the vehicle;

FIG. 2A schematically depicts a cross section of the accessory mounting assembly in a locked position, taken along the lines I-I of FIG. 1, according to one or more embodiments shown and described herein;

FIG. 2B schematically depicts a cross section of the accessory mounting assembly in an unlocked position, taken along the lines I-I of FIG. 1, according to one or more embodiments shown and described herein;

FIG. 2C schematically depicts a partial perspective view of the truck bed having raised front connectors and rear connectors, according to one or more embodiments shown and described herein;

FIG. 3A schematically depicts a cross section of another accessory mounting assembly in a locked position, taken along the lines I-I of FIG. 1, according to one or more embodiments shown and described herein;

FIG. 3B schematically depicts a cross section of the accessory mounting assembly of FIG. 3A in an unlocked position, according to one or more embodiments shown and described herein;

FIG. 4A schematically depicts a cross section of another accessory mounting assembly in a locked position, taken along the lines I-I of FIG. 1, according to one or more embodiments shown and described herein; and

FIG. 4B schematically depicts a partial perspective view of the truck bed having recessed front connectors and rear connectors, according to one or more embodiments shown and described herein.

### DETAILED DESCRIPTION

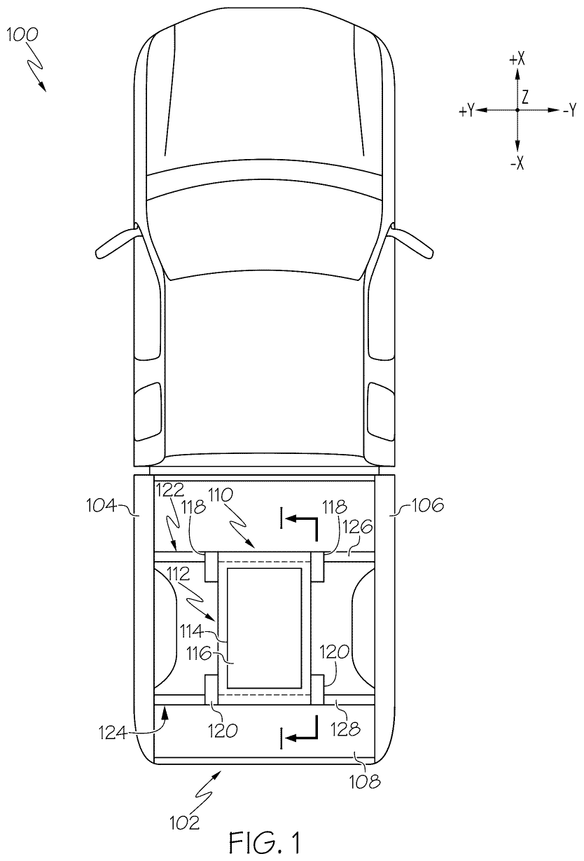

FIG. 1 schematically depicts a vehicle, a truck bed, and an accessory mounting assembly. The truck bed includes a pair of side walls and a floor. The accessory mounting assembly having an accessory and a front connector and a rear connector coupled to the floor. The accessory is configured to be releasably coupled to the floor. The accessory includes a housing defining a storage space, a front latch and a rear latch, the front latch and the rear latch are coupled to the housing, the front latch and the rear latch are movable between a locked position and an unlocked position, in the locked position the front latch engages with the front connector and the rear latch engages with the rear connector to inhibit movement of the housing with respect to the floor, in the unlocked position the front latch is disengaged with the front connector and the rear latch is disengaged with the rear connector to permit the housing to move with respect to the floor.

As used herein, the terms “vehicle longitudinal direction”, refer to the forward-rearward direction of the vehicle (i.e., in the +/− X direction of the coordinate axes depicted in FIG. 1). The term “vehicle lateral direction” refers to the cross-vehicle direction (i.e., in the +/− Y direction of the coordinate axes depicted in FIG. 1), and is transverse to the vehicle longitudinal direction. The terms “vehicle vertical direction”, refer to the upward-downward direction of the vehicle (i.e., in the +/− Z direction of the coordinate axes depicted in FIG. 1). As used herein, “upper” and “above” are defined as the positive Z dir ection of the coordinate axes shown in the drawings. “Lower” and “below” are defined as the negative Z direction of the coordinate axes shown in the drawings.

Referring to FIG. 1, a vehicle 100 is shown having an accessory mounting assembly 110. FIG. 1 is an embodiment in which the vehicle 100 is configured as a pickup truck having a truck bed 102, with the accessory mounting assembly 110 mounted to the truck bed 102. However, the accessory mounting assembly 110 may be used in other locations within the vehicle 100, such as a trunk, a passenger cabin, a cargo area, etc. Furthermore, the location shown in FIG. 1 is merely demonstrative and may vary in position, size, number, etc. Moreover, while the vehicle 100 shown in FIG. 1 is configured as a pickup truck, the accessory mounting assembly 110 may be used in any configuration of a vehicle (e.g., a passenger car, a van, a sport-utility vehicle, a crossover vehicle, airplane, boat, etc.) and may be used in any suitable location within the vehicle 100.

The truck bed 102 includes a first side wall 104, an opposite second side wall 106, and a floor 108 extending between the first side wall 104 and the second side wall 106. The first side wall 104 and the second side wall 106 are positioned on parallel planes. The first side wall 104 and the second side wall 106 extend perpendicular to the floor 108. The accessory mounting assembly 110 includes an accessory 112, a front connector 122, and a rear connector 124. The accessory 112 includes a housing 114, at least one front latch 118, and at least one rear latch 120. While the accessory 112 shown in FIG. 1 includes a pair of front latches 118 and a pair of rear latches 120, the accessory 112 is not limited thereto.

The housing 114 includes a storage space 116. Examples of the housing 114 include coolers, refrigerators, tool chests, drawers, and storage containers. The front latch 118 engages with the front connector 122. The rear latch 120 engages with the rear connector 124. The front latch 118 is more proximal to the front of the vehicle 100 in the vehicle longitudinal direction, and the rear latch 120 is more distal to the front of the vehicle 100 in the vehicle longitudinal direction. In FIG. 1, the front connector 122 is a front rail 126 and the rear connector 124 is a rear rail 128. As shown in FIG. 1, the front rail 126 and the rear rail 128 each extend between the first side wall 104 and the second side wall 106 and are each spaced apart from the floor 108. However, the front rail 126 and the rear rail 128 may be spaced apart from the first side wall 104 and the second side wall 106 and may extend discontinuously between the first side wall 104 and the second side wall 106.

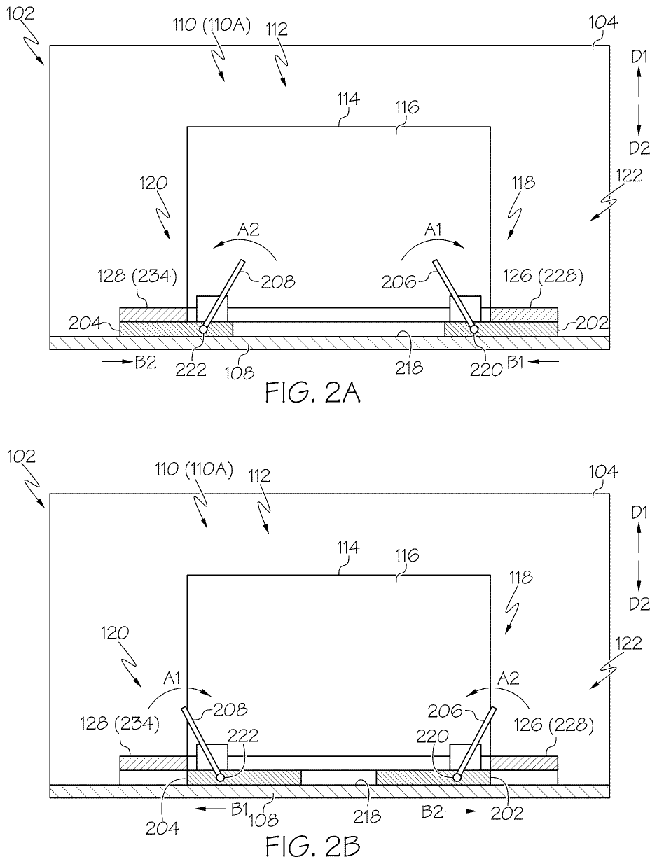

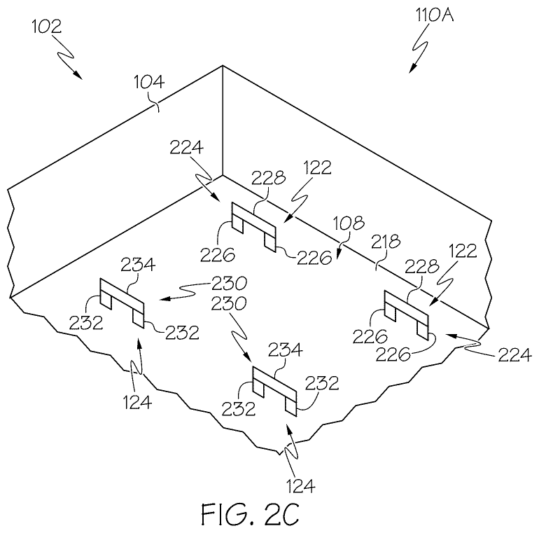

Referring to FIGS. 2A and 2B, a cross-section of the accessory mounting assembly 110 is shown. The floor 108 includes a floor surface 218 as the top surface to the floor 108 of the truck bed 102. In this embodiment, the front rail 126 and the rear rail 128 are spaced apart from the floor surface 218 of the floor 108 in the vehicle vertical direction. The front latch 118 includes a front hook 202 and a front lever 206. The front lever 206 is pivotally attached to the front hook 202 at a front pivotal joint 220. The rear latch 120 includes a rear hook 204 and a rear lever 208. The rear lever 208 is pivotally attached to the rear hook 204 at a rear pivotal joint 222.

The front latch 118 and the rear latch 120 are moveable in between a locked position, as shown in FIG. 2A, and an unlocked position, as shown in FIG. 2B. In the locked position, the front latch 118 engages the front connector 122 and the rear latch 120 engages the rear connector 124 to inhibit movement of the housing 114 with respect to the floor 108 in a removal direction D1 to secure the housing 114 to the truck bed 102. In the unlocked position, the front latch 118 is disengaged with the front connector 122 and the rear latch 120 is disengaged with the rear connector 124 to permit movement of the housing 114 with respect to the floor 108 in a removal direction D2 to allow for the housing 114 to be removed from the truck bed 102 or in an installation direction D2 to allow for the housing 114 to be installed to the truck bed 102.

The front hook 202 and the rear hook 204 are moveable between an engaged position, as shown in FIG. 2A, and a disengaged position, as shown in FIG. 2B. In the locked position the front hook 202 and the rear hook 204 are in the engaged position. In the unlocked position, the front hook 202 and the rear hook 204 are in the disengaged position. In the engaged position, the front hook 202 engages with the front connector 122 and the rear hook 204 engages with the rear connector 124. Specifically, in the engaged position the front hook 202 is at least partially positioned between the front rail 126 and the floor surface 218 and the rear hook 204 is at least partially positioned between the rear rail 128 and the floor surface 218. In the disengaged position, the front hook 202 is spaced apart from the front rail 126 and the rear hook 204 is spaced apart from the rear rail 128.

The front lever 206 and the rear lever 208 are moveable between a closed position, as shown in FIG. 2A, and an open position, as shown in FIG. 2B. As shown in FIG. 2A, when the front latch 118 and the rear latch 120 are in the locked position, the front hook 202 and the rear hook 204 are in the engaged position and the front lever 206 and the rear lever 208 are in the closed position. As shown in FIG. 2B, when the front latch 118 and the rear latch 120 are in the unlocked position, the front hook 202 and the rear hook 204 are in the disengaged position and the front lever 206 and the rear lever 208 are in the open position.

The front lever 206 is coupled to the front hook 202 such that movement of the front lever 206 from the closed position to the open position, in the direction of arrow A1 of FIG. 2A, moves the front hook 202, in the direction of arrow B1 of FIG. 2A, from the engaged position to the disengaged position to move the front latch 118 from the locked position to the unlocked position. The rear lever 208 is coupled to the rear hook 204 such that movement of the rear lever 208 from the closed position to the open position, in the direction of arrow A2 of FIG. 2A, moves the rear hook 204, in the direction of arrow B2 of FIG. 2A, from the engaged position to the disengaged position to move the rear latch 120 from the locked position to the unlocked position.

The front lever 206 is coupled to the front hook 202 such that movement of the front lever 206 from the open position to the closed position, in the direction of arrow A2 of FIG. 2B, moves the front hook 202, in the direction of arrow B2 of FIG. 2B, from the disengaged position to the engaged position to move the front latch 118 from the unlocked position to the locked position. The rear lever 208 is coupled to the rear hook 204 such that movement of the rear lever 208 from the open position to the closed position, in the direction of arrow A1 of FIG. 2B, moves the rear hook 204, in the direction of arrow B1 of FIG. 2B, from the disengaged position to the engaged position to move the rear latch 120 from the unlocked position to the locked position.

Referring to FIG. 2C, another embodiment of an accessory mounting assembly 110A is illustrated. The accessory mounting assembly 110A is similar in structure and operation to the accessory mounting assembly 110 except that the front connector 122 is formed as at least one front cleat 224 instead of a front rail 126 and the rear connector 124 is formed as at least one rear cleat 230 instead of the rear rail 128. FIG. 2C illustrates a pair of front cleats 224 and a pair of rear cleats 230. The front cleat 224 includes a pair of front legs 226 and a front arm 228. The rear cleat 230 includes a pair of rear legs 232 and a rear arm 234. The front legs 226 and the rear legs 232 extend upwardly from the floor surface 218 of the floor 108 substantially perpendicularly to the floor 108. The front arm 228 and the rear arm 234 extend between the front legs 226 and the rear legs 232, respectively, such that the front arm 228 and the rear arm 234 are spaced apart from the floor surface 218 of the floor 108 of the truck bed 102. The operation of the accessory mounting assembly 110A with the front cleat 224 and rear cleat 230 is the same as described with reference to the accessory mounting assembly 110A in FIGS. 2A and 2B. In the engaged position, the front hook 202 is positioned between the floor surface 218 and the front arm 228 of the front cleat 224 and positioned between the pair of front legs 226. In the engaged position, the rear hook 204 is positioned between the floor surface 218 and the rear arm 234 of the rear cleat 230 and positioned between the pair of rear legs 232. In the disengaged position, the front hook 202 is spaced apart from the front arm 228 of the front cleat 224. In the disengaged position, the rear hook 204 is spaced apart from the rear arm 234 of the rear cleat 230.

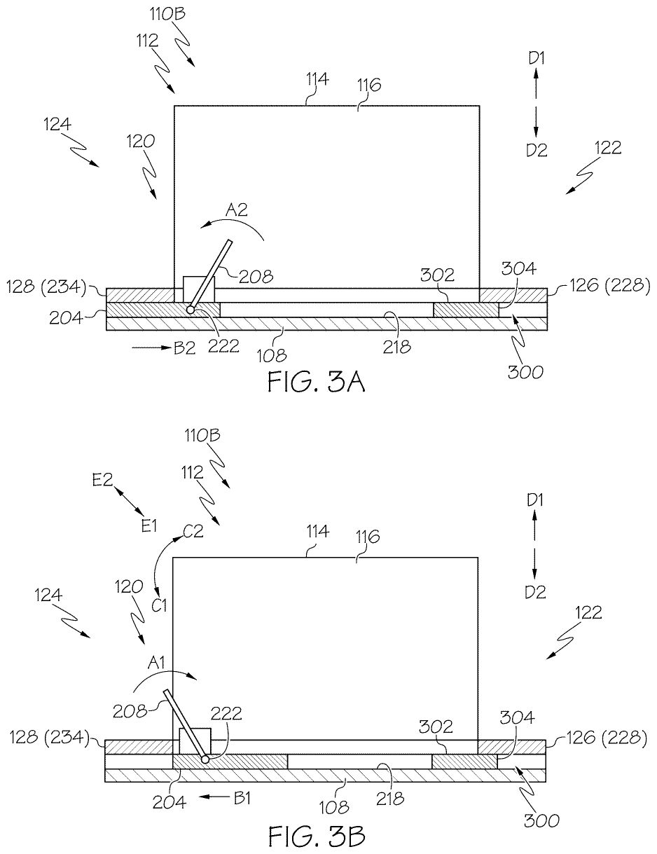

Referring to FIGS. 3A and 3B, another embodiment of an accessory mounting assembly 110B is illustrated. The accessory mounting assembly 110B is similar in structure and operation to the accessory mounting assembly 110 and the accessory mounting assembly 110A except that one of the front latch 118 or the rear latch 120 is replaced with a fixed claw 300. Although FIGS. 3A and 3B illustrate that the front latch 118 is replaced with the fixed claw 300, the accessory mounting assembly 110B may include the front latch 118 and replace the rear latch 120 with the fixed claw 300. The accessory mounting assembly 110B may include the front connector 122 and the rear connector 124 as the front rail 126 and the rear rail 128 of the accessory mounting assembly 110 or as the front cleat 224 and the rear cleat 230 of the accessory mounting assembly 110A.

Referring to FIGS. 3A and 3B, the fixed claw 300 includes a housing portion 302 and a protruding portion 304. The housing portion 302 is fixed to the housing 114. The protruding portion 304 protrudes outwardly from the housing 114. The structure and operation of the rear latch 120 is the same as in the accessory mounting assembly 110.

As shown in FIG. 3A, the rear latch 120 is in the locked position with the rear hook 204 in the engaged position and the rear lever 208 in the closed position. The protruding portion 304 is engaged with the front connector 122 such that the protruding portion 304 is positioned between the front connector 122 and the floor surface 218. In order to remove the housing 114 from the truck bed 102, the rear latch 120 is moved from the locked position to the unlocked position. Then the housing 114 is rotated in the direction of arrow C2 such that a rear end of the housing 114 is spaced apart from the floor surface 218 a distance greater than a distance between the floor surface 218 and an upper surface of the rear connector 124. Next, the housing 114 is moved in the direction of arrow E2 to disengage the protruding portion 304 of the fixed claw 300 from the front connector 122. Upon disengagement of the protruding portion 304 with the front connector 122, the housing 114 is removed in the direction of arrow D1.

In order to install the housing 114 to the truck bed 102, the housing 114 is moved in the direction of arrow E1 until the protruding portion 304 engages with the front connector 122. Then the housing 114 is rotated in the direction of arrow C1 until the rear end of the housing 114 contacts the floor surface 218. Next, the rear latch 120 is moved from the unlocked position to the locked position.

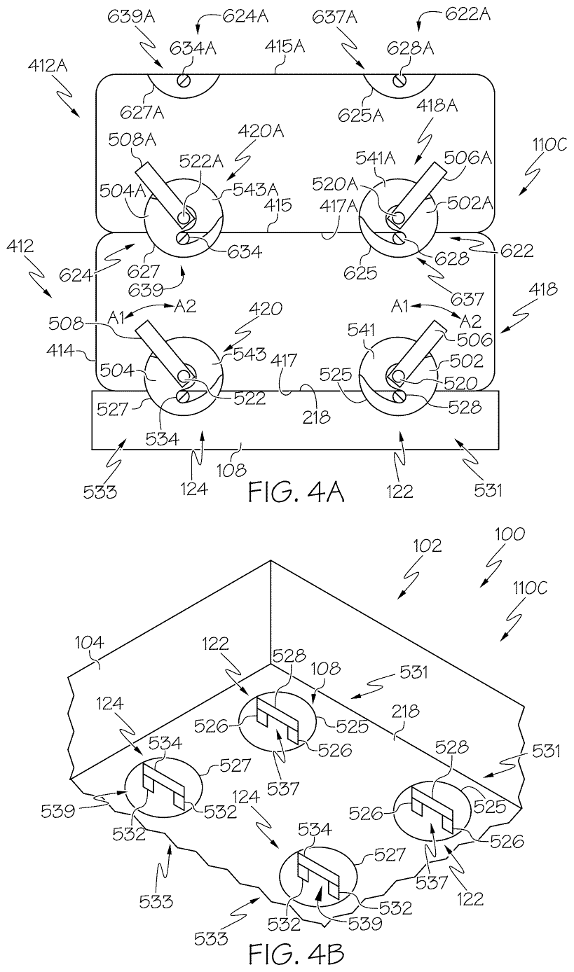

Referring to FIG. 4A, another embodiment of an accessory mounting assembly 110C is illustrated. The accessory mounting assembly 110C includes a first accessory 412, the front connector 122, and the rear connector 124. The first accessory 412 includes a housing 414 having an upper surface 415 and an opposite bottom surface 417, at least one front latch 418, and at least one rear latch 420. It is appreciated, that the accessory 412 may include a pair of front latches 418 and a pair of rear latches. The front latch 418 includes a front cutout 541 that at least partially extends into the housing 414 from the bottom surface 417. The front latch 418 includes a front hook 502 and a front lever 506 coupled to the front hook 502. The front hook 502 is at least partially received within the front cutout 541. The front hook 502 is pivotally connected to the housing 414 at a front pivotal joint 520. The rear latch 420 includes a rear cutout 543 that at least partially extends into the housing 414 from the bottom surface 417. The rear latch 420 includes a rear hook 504 and a rear lever 508 coupled to the rear hook 504. The rear hook 504 is at least partially received within the rear cutout 543. The rear hook 504 is pivotally connected to the housing 414 at a rear pivotal joint 522.

The front latch 418 and rear latch 420 of the accessory mounting assembly 110C are similar in operation to the front latch 118 and rear latch 120 of the accessory mounting assembly 110A. The front lever 506 is coupled to the front hook 502 such that movement of the front lever 506 from the closed position to the open position, in the direction of arrow A1 of FIG. 4A, moves the front latch 418 from the locked position to the unlocked position. Movement of the rear lever 508 in the direction of arrow A2 of FIG. 4A, moves the rear latch 420 from the locked position to the unlocked position. The front lever 506 is coupled to the front hook 502 such that movement of the front lever 506 from the open position to the closed position, in the direction of arrow A2 of FIG. 4A, moves the front latch 418 from the unlocked position to the locked position. Movement of the rear lever 508 in the direction of arrow A1 of FIG. 4A, moves the rear latch 420 from the unlocked position to the locked position.

Referring to FIG. 4B, in the accessory mounting assembly 110C, the front connector 122 is formed as at least one front recessed anchor 531 and the rear connector 124 is formed as at least one rear recessed anchor 533. FIG. 4B illustrates a pair of front recessed anchors 531 and a pair of rear recessed anchors 533. The front recessed anchor 531 includes a front recess 525 and a front anchor 537. The rear recessed anchor 533 includes a rear recess 527 and a rear anchor 539. The front recess 525 and the rear recess 527 are recessed with respect to the floor surface 218. The front anchor 537 is positioned within the front recess 525. The rear anchor 539 is position within the rear recess 527. The front anchor 537 includes a pair of front legs 526 and a front arm 528. The rear anchor 539 includes a pair of rear legs 532 and a rear arm 534. The front legs 526 and the rear legs 532 extend upwardly from a bottom surface of the front recess 525 and the rear recess 527, respectively. The front arm 528 and the rear arm 534 extend between the front legs 526 and the rear legs 532, respectively, such that the front arm 528 and the rear arm 534 are spaced apart from the bottom surface of the front recess 525 and the rear recess 527, respectively. In embodiments, an upper surface of the front arm 528 and an upper surface of the rear arm 534 are positioned flush with the floor surface 218. In embodiments, the upper surface of the front arm 528 and the upper surface of the rear arm 534 are positioned below the floor surface 218 in the vehicle vertical direction.

Referring to FIGS. 4A and 4B, the housing 414 includes an upper front connector 622 and an upper rear connector 624. The upper front connector 622 and the upper rear connector 624 have the same structure as the front recessed anchor 531 and the rear recessed anchor 533. The upper front connector 622 includes an upper front recess 625 and an upper front anchor 637. The upper rear connector 624 includes an upper rear recess 627 and an upper rear anchor 639. The upper front recess 625 and the upper rear recess 627 are recessed with respect to the upper surface 415 of the housing 414. The upper front anchor 637 is positioned within the upper front recess 625. The upper rear anchor 639 is positioned within the upper rear recess 627. The upper front anchor 637 includes a pair of upper front legs and an upper front arm 628 similar to the front anchor 537. The upper rear anchor 639 includes a pair of upper rear legs and an upper rear arm 634 similar to the rear anchor 539. The upper front legs and the upper rear legs extend upwardly from a bottom surface of the upper front recess 625 and the upper rear recess 627, respectively. The upper front arm 628 and the upper rear arm 634 extend between the upper front legs and the upper rear legs, respectively, such that the upper front arm 628 and the upper rear arm 634 are spaced apart from the bottom surface of the upper front recess 625 and the upper rear recess 627, respectively. In embodiments, an upper surface of the upper front arm 628 and an upper surface of the rear arm 634 are positioned flush with the upper surface 415 of the housing 414. In embodiments, the upper surface of the front arm 628 and the upper surface of the rear arm 634 are positioned below the upper surface 415 of the housing 414 in the vehicle vertical direction.

The operation of the accessory mounting assembly 110C with the front recessed anchor 531 and the rear recessed anchor 533 is the same as described with reference to the accessory mounting assembly 110A. In the engaged position, the front hook 502 engages the front arm 528 of the front anchor 537 and is positioned between the pair of front legs 526. In the engaged position, the rear hook 504 engages the rear arm 534 of the rear anchor 539 and is positioned between the pair of rear legs 532. In the disengaged position, the front hook 502 is disengaged from the front arm 528 of the front anchor 537. In the disengaged position, the rear hook 504 is disengaged from the rear arm 534 of the rear anchor 539. The front lever 506 is movable between the closed position and the open position and is coupled to the front hook 502. Movement of the front lever 506 between the closed position and the open position moves the front hook 502 between the engaged position and the disengaged position to move the front latch 418 between the locked position and the unlocked position. The rear lever 508 is movable between the closed position and the open position and is coupled to the rear hook 504. Movement of the rear lever 508 between the closed position and the open position moves the rear hook 504 between the engaged position and the disengaged position to move the rear latch 420 between the locked position and the unlocked position.

The accessory mounting assembly 110C includes a supplemental accessory 412A having the same structure as the accessory 412. As such, like reference characters of the accessory 412 are designated with an “A” in the supplemental accessory 412A. Specifically, the supplemental front latch 418A and the supplemental rear latch 420A of the supplemental accessory 412A are configured to couple with the upper front connector 622 and the upper rear connector 624, respectively, to couple the supplemental accessory 412A to the accessory 412. Although FIG. 4A illustrates only one supplemental accessory 412A, additional supplemental accessories may be provided.

From the above, it is to be appreciated that defined herein is a vehicle 100 having a truck bed 102 and an accessory mounting assembly 110. The truck bed 102 includes a first side wall 104 and a second side wall 106 and a floor 108. The accessory mounting assembly 110 includes a front connector 122, a rear connector 124, a housing 114, a front latch 118 and a rear latch 120. The accessory 112 is configured to be releasably coupled to the floor 108. The front latch 118 and the rear latch 120 are movable between a locked position and an unlocked position, in the locked position the front latch 118 engages with the front connector 122 and the rear latch 120 engages with the rear connector 124 to inhibit movement of the housing 114 with respect to the floor 108, in the unlocked position the front latch 118 is disengaged with the front connector 122 and the rear latch 120 is disengaged with the rear connector 124 to permit the housing 114 to move with respect to the floor 108.

As used herein, the singular forms “a,” “an” and “the” include plural referents unless the context clearly dictates otherwise. Thus, for example, reference to “a” component includes aspects having two or more such components, unless the context clearly indicates otherwise.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a truck bed having a pair of side walls and a floor; and
an accessory mounting assembly having an accessory and a front connector and a rear connector coupled to the floor, the accessory configured to be releasably coupled to the floor, the accessory includes a housing defining a storage space, a front latch and a rear latch, the front latch and the rear latch are coupled to the housing, the front latch and the rear latch are movable between a locked position and an unlocked position, in the locked position the front latch engages with the front connector and the rear latch engages with the rear connector to inhibit movement of the housing with respect to the floor, in the unlocked position the front latch is disengaged with the front connector and the rear latch is disengaged with the rear connector to permit the housing to move with respect to the floor.

2. The vehicle according to claim 1, wherein the front latch includes a front hook and the rear latch includes a rear hook, the front hook and the rear hook are moveable between an engaged position and a disengaged position, in the locked position the front hook and the rear hook are in the engaged position, in the unlocked position the front hook and the rear hook are in the disengaged position, in the engaged position the front hook engages the front connector and the rear hook engages the rear connector, and in the disengaged position the front hook is spaced apart from the front connector and the rear hook is spaced apart from the rear connector.

3. The vehicle according to claim 2, wherein the front latch includes a front lever and the rear latch includes a rear lever, the front lever and the rear lever are movable between an open position and a closed position,
wherein movement of the front lever and the rear lever from the open position to the closed position moves the front hook and the rear hook from the disengaged position to the engaged position to move the front latch and the rear latch from the unlocked position to the locked position, and movement of the front lever and the rear lever from the closed position to the open position moves the front hook and the rear hook from the engaged position to the disengaged position to move the front latch and the rear latch from the locked position to the unlocked position.

4. The vehicle according to claim 3, wherein the front connector is a front rail that extends between the pair of side walls and spaced apart from the floor, and the rear connector is a rear rail that extends between the pair of side walls and spaced apart from the floor.

5. The vehicle according to claim 3, wherein the front connector is a front anchor provided in a front recess in the floor and the rear connector is a rear anchor provided in a rear recess in the floor, the front anchor and the rear anchor are positioned below a floor surface of the floor.

6. The vehicle according to claim 5, wherein the housing includes an upper front anchor and an upper rear anchor, the upper front anchor is provided in an upper front recess formed in an upper surface of the housing, and the upper rear anchor is provided in an upper rear recess formed in the upper surface of the housing,
wherein the vehicle further comprises a supplemental accessory configured to be releasably coupled to the housing of the accessory, the supplemental accessory includes a supplemental front latch and a supplemental rear latch, the supplemental front latch and the supplemental rear latch are movable between a locked position and an unlocked position, in the locked position the supplemental front latch engages with the upper front anchor on the accessory and the supplemental rear latch engages with the upper rear anchor on the accessory to inhibit movement of the supplemental accessory with respect to the housing, and in the unlocked position the supplemental front latch is disengaged with the upper front anchor and the supplemental rear latch is disengaged with the upper rear anchor to permit movement of the supplemental accessory with respect to the housing.

7. The vehicle according to claim 3, wherein the front connector is a front cleat having a front leg extending upwardly from a floor surface of the floor and a front arm spaced apart from the floor surface, and the rear connector is a rear cleat having a rear leg extending upwardly from the floor surface and a rear arm spaced apart from the floor surface of the floor.

8. The vehicle according to claim 7, wherein in the engaged position the front hook is at least partially positioned between the front arm and the floor surface and the rear hook is at least partially positioned between the rear arm and the floor surface.

9. The vehicle according to claim 8, wherein the front lever is pivotally coupled to the front hook and the rear lever is pivotally coupled to the rear hook.

10. The vehicle according to claim 9, wherein upon movement of the front lever from the open position towards the closed position the front hook moves in a first direction from the disengaged position towards the engaged position and upon movement of the rear lever from the open position towards the closed position the rear hook moves in a second direction opposite the first direction from the disengaged position towards the engaged position.

11. The vehicle according to claim 10, wherein upon movement of the front lever from the closed position towards the open position the front hook moves in the second direction from the engaged position towards the disengaged position and upon movement of the rear lever from the closed position towards the open position the rear hook moves in the first direction from the engaged position towards the open disengaged position.
